(19) United States
(12) Patent Application Publication
(10) Pub. No.: US 2006/0035631 A1
(43) Pub. Date: Feb. 16, 2006

(54) Wireless device service activation from the wireless device

(76) Inventors: Christopher White, Redmond, WA (US); James L. Cannon, Bellevue, WA (US)

Correspondence Address: PERKINS COIE LLP/AWS, P.O. BOX 1247, SEATTLE, WA, 98111-1247, US

(21) Appl. No.: 10/918,697

(22) Filed: Aug. 13, 2004

(51) Int. Cl. H04M 3/00

(52) U.S. Cl. 455/418; 455/419; 455/411

(57) ABSTRACT

A method and system for facilitating activation of a mobile device by an end user, where the end user may initiate the activation from the mobile device. Prior to activation, the mobile device is configured with a permanent identifier that is known by a select network service provider. The inactive mobile device sends a request for access that is ultimately received at a system of the service provider. The request includes the permanent identifier. Based on the permanent identifier, if the service provider recognizes the mobile device as having an inactive status, it provides the mobile device with access to an activation component portion of the system. Once the mobile device has access to the activation component, the end user of the mobile device can provide the activation component with activation information so that the mobile device can be activated and have increased access to the system.

### BACKGROUND

Manufacturers of wireless communication devices, such as mobile phones and personal digital assistants (PDAs), typically package and ship such devices to distributors and retailers in an “inactive” state, meaning they have limited network connection capabilities right out of the package. In some cases, an inactive mobile device may be capable of making registration requests (or the like) to request access to various components of a surrounding wireless network. However, such requests (except for 911 calls) often remain more or less ineffective, as the device is not yet recognized as “belonging” to any particular service provider network. For example, in the case of mobile phones, it is typically only after subscribing to a service offered by a wireless carrier that a user of the mobile phone may make or receive nonemergency calls using the device.

In the process of activating a mobile device, the end user of the device typically provides personal information, billing information, and subscription preferences to a service representative (e.g., at the retail store, by phone, or even via a web site). The service representative (usually a trained technician) then activates the device by entering codes and other information into a selected wireless service provider's system. This can be a lengthy and involved process for the both the end user and the service representative. Because of the time and expertise needed to activate a wireless device in this way, activation can be a costly process for which more effective solutions are sought. In addition, this type of activation can result in delays for the customer. The inconvenience may also discourage a customer from changing to a new service provider or device, even though such a change would be beneficial for the customer. Other problems exist.

### BRIEF DESCRIPTION OF THE DRAWINGS

FIG. 1 is a block diagram showing an example of a system on which the activation of the mobile device from the mobile device may be implemented in one embodiment.

FIG. 2 is a block diagram showing an example of a Wi-Fi system on which the activation of the mobile device from the mobile device may be implemented in one embodiment.

FIG. 3 is a block diagram showing a more detailed example of the activation component of FIG. 1.

FIG. 4 is a block diagram showing an example of an identification coding scheme, such as for the mobile device of FIG. 1 or the Wi-Fi card of FIG. 2.

FIG. 5 is a flow diagram showing an example of a routine at a wireless service provider system for processing an activation request from a mobile device.

FIG. 6 is a flow diagram showing an example of a routine at an activation component for activating a mobile device.

FIG. 7 is a flow diagram showing an example of a routine at a mobile device for requesting activation.

FIG. 8 is a flow diagram showing an example of a process for configuring a mobile device that can be activated from the mobile device by an untrained user.

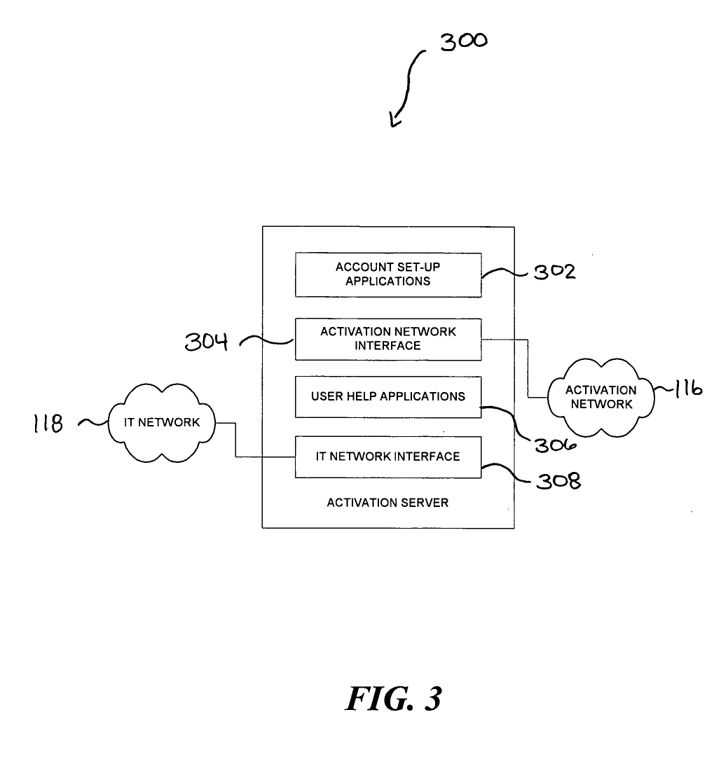

In the drawings, the same reference numbers and acronyms identify elements or acts with the same or similar functionality for ease of understanding and convenience. To easily identify the discussion of any particular element or act, the most significant digit or digits in a reference number refer to the Figure number in which that element is first introduced (e.g., element 304 is first introduced and discussed with respect to FIG. 3).

### DETAILED DESCRIPTION

I. Overview

A mobile device activation scheme allows an untrained end-user of an inactive mobile device to activate the mobile device from the mobile device itself. The activation of the mobile device may involve the mobile device communicating with an activation component associated with a service provider system (e.g., network service provider, wireless carrier, etc.). A mobile device manufacturer configures the mobile device with a permanent identifier (e.g., an international mobile subscriber identifier (IMSI) or some other non-temporary identification code) that is preassociated with a select service provider.

Prior to the activation of the mobile device, the service provider stores information associated with this identifier at an appropriate registry or storage location (e.g., in a data record or customer record database at a home location register of the service provider). This allows the network of the service provider to recognize the device when it initially attempts to register on the network after being turned on. Alternatively, the service provider may refrain from storing an individual record for the non-activated device's identifier. Instead, the service provider may use a default or derived set of information for identifiers that have no information in the registry. In general, the service provider may also store information regarding the status of the device (e.g., active status vs. inactive status).

In some embodiments, inactive devices configured as described above have limited access to the network of the service provider. A customer record or data record associated with the mobile device identifier of the inactive device may specify the extent of the limited access. For example, the limited access may allow the user of the device to access an activation network and/or activation component of the service provider network so that the user may use the mobile device to perform activation steps. Activation steps may include selecting an available service program or subscription offered by the service provider and providing billing information.

In addition to having permission to interact with the activation network, the inactive device may also have permission to receive short message service (SMS) messages, send SMS messages, etc., thereby further enabling a variety of possible activation steps. Once the user has provided enough information so that the device may be appropriately activated, the data or customer record at the home location register (HLR) or network node may be updated to reflect such changes. In this way, the next time that the device attempts to register or otherwise communicate with the network of the service provider, the device is provided with a greater level of access to the wireless network.

In some embodiments, one or more nodes at the wireless service provider system may track the status of the device prior to activation. When the device then initiates the activation process, the device may request information about its current status. In some embodiments, activation-related applications or processes at the mobile device may use the status information (and other information received from the wireless service provider system) in facilitating activation of the mobile device, including interacting with the user to obtain user information requested by the activation network.

The activation scheme may be implemented in a variety of networks or combination of networks, including wireless telecommunications networks (GSM/GPRS, cellular, PSTN, TDMA, etc.), local area networks (LANs), wide area networks (WANs), Wi-Fi networks, the Internet, communications networks including a personal base station configuration, etc. The activated service may include mobile telephone service, Internet service, media entertainment services such as set-top box activation, on-demand, or pay-per-view, etc. Likewise, the mobile device can be of almost any type, including mobile phones, laptop personal computers, Wi-Fi transceivers or cards, PDAs, notebook computers, EDGE (enhanced data rates for global evolution) cards, portable entertainment centers, etc.

The invention will now be described with respect to various embodiments. The following description provides specific details for a thorough understanding of, and enabling description for, these embodiments of the invention. However, one skilled in the art will understand that the invention may be practiced without these details. In other instances, well-known structures and functions have not been shown or described in detail to avoid unnecessarily obscuring the description of the embodiments of the invention.

The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

II. System Architecture

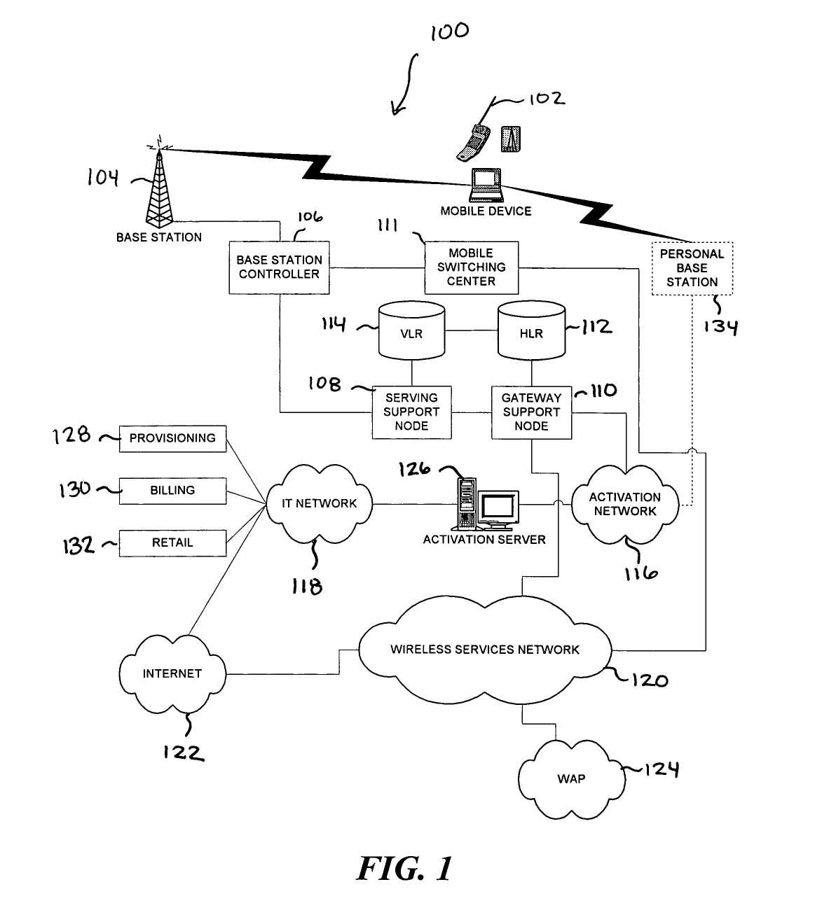

FIGS. 1-3 and the following discussion provide a brief, general description of a suitable computing/network environment in which the invention can be implemented. Although not required, aspects of the invention are described in the general context of computer-executable instructions, such as routines executed by a general-purpose computer, e.g., a server computer, wireless device, or personal computer. Those skilled in the relevant art will appreciate that the invention can be practiced with other communications, data processing or computer system configurations, including Internet appliances, hand-held devices (including PDAs), wearable computers, all manner of cellular or mobile phones, multi-processor systems, microprocessor-based or programmable consumer electronics, set-top boxes, network PCs, minicomputers, mainframe computers, and the like. Indeed, the terms “computer,” “device,” and “component” are generally used broadly and interchangeably, and refer to any of the above devices and systems, as well as any data processor.

Aspects of the invention can be embodied in a special purpose computer or data processor that is specifically programmed, configured, or constructed to perform one or more of the computer-executable instructions explained in detail herein. Aspects of the invention can also be practiced in distributed computing environments where tasks or modules are performed by remote processing devices, which are linked through a communications network, such as a LAN, WAN, or the Internet. In a distributed computing environment, program modules may be located in both local and remote memory storage devices.

Aspects of the invention may be stored or distributed on computer-readable media, including magnetically or optically readable computer discs, hard-wired or preprogrammed in chips (e.g., EEPROM semiconductor chips), nanotechnology memory, photonic memory, biological-based memory, or other data storage media. Indeed, computer implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or may be provided on any analog or digital network (packet switched, circuit switched, or other scheme). Those skilled in the relevant art will recognize that portions of the invention reside on a server computer, while corresponding portions reside on a client computer such as a mobile or portable device, and thus, while certain hardware platforms are described herein, aspects of the invention are equally applicable to nodes on a network.

Referring to FIG. 1, a system 100 on which the activation of the mobile device from the mobile device may be implemented is shown. The system of FIG. 1 is an example of a GPRS (general packet radio service) system based on GSM (global system for mobile communication). However, the invention may be implemented on other types of systems, including a variety of cellular systems. The system 100 includes a mobile device 102 (e.g., mobile phone, PDA, wireless laptop, etc.) in communication with a base station 104. A base station controller 106 in communication with a serving GPRS support node (SGSN) 108 and a gateway GPRS support node (GGSN) 110 together support packet switched transactions, which are handled separately from circuit switched traffic that is supported by a mobile switching center (MSC) 111. The MSC 111 also serves as an access point for the Public Switched Telephone Network.

The SGSN 108, GGSN 110, and MSC 111 interact with a home location register 112 (HLR). In some embodiments, the HLR 112 is the primary database of permanent subscriber/customer information for the service provider's mobile network. In the context of activated devices, the HLR 112 may contain pertinent user information, including address information, account status, and preferences. In some embodiments, a visiting location register (VLR) 114 manages requests from out-of-area subscribers who are out of the area covered by their home system.

In the context of inactive devices, the HLR 112 may contain a record of a permanent identifier of the mobile device and an indication that the device is not active. In some embodiments, the inactive mobile device or a module in the inactive mobile device, such as a SIM (subscriber identity module) card, is configured at manufacturing time with this permanent identifier. In this way, when the nonactivated device attempts to register after being turned on, the system recognizes the device and provides it with the appropriate level of access (e.g., activation network access, SMS capabilities, etc.) so that the untrained user can complete activation from the mobile device. Once the device is activated, the HLR 112 can continue to store information regarding the extent of access that the device has to the network. In some embodiments, the extent of access of the activated device is based on the selected service plan.

The initial writing of data, including the writing of permanent identification codes associated with inactive devices to the HLR 112 (prior to activation) may occur either before or after the mobile device is manufactured. For example, the manufacturer may send a list of permanent identification codes (each corresponding to a wireless device or to a module in the wireless device, such as a SIM card) to the wireless service provider. The wireless service provider may then write the codes to records at the HLR 112. In an alternative scenario, the wireless service provider may provide a list of permanent identification codes numbers to the manufacturer, so that the manufacturer can configure batches of devices accordingly. Once activation takes place, the initial records in the HLR 112 may be swapped or updated to a more complete HLR record that allows for less restricted access to the network, services, nodes, and systems of the wireless service provider.

In the illustrated embodiment, the system 100 includes three distinct network components, including an activation network 116, an IT network 118, and a wireless services network 120. Other networks that may be related to the system 100 include the Internet 122 and a Wireless Application Protocol (WAP) network 124. The activation network 116 may be associated with an activation server 126 that manages one or more activation processes, so that the end user may activate the mobile device 102 by means of the mobile device itself. Aspects of the activation network 116 and activation server 126 are described in more detail with respect to FIG. 3.

In some embodiments, the HLR 112 has a customer record that indicates which of the network components the device can connect to and which it cannot. For example, when the mobile device is shipped from the manufacturer, in some embodiments, the only network component that the device is allowed to connect to is the activation network 116. Once there is provisioning to the HLR 112 through the activation process, the device may be allowed to access other networks such as the wireless services network 120.

The IT network 118 may include a provisioning server 128 that facilitates the writing of data to the HLR 112. The IT network 118 may also handle billing functionality 130 and other services, such as retail services functionality 132. The activation server 126 may communicate with aspects of the IT network 118 so that activation of the mobile device 102 may be completed. For example, the provisioning server 128 may facilitate the writing of activation data to the HLR 112 after the end user provides information to activate the mobile device 102.

The system 100 may include one or more optional personal base stations (PBSs) 134 that enable customers to integrate their wireless phones into a fixed, home-based system. In some embodiments the PBS 134 is located in or near the home or business of the user. The PBS 134 effectively treats the mobile device as a short range mobile device (e.g., cordless phone) when the user is inside the home or business. When the mobile device leaves the range of the PBS 134, it then communicates via regular base stations, such as base station 104. When activation of the mobile device is implemented using a PBS configuration, the PBS 134 interacts directly with the activation server 126, so that the base station and HLR lookup steps may be bypassed. Communications between the activation server 126 and the PBS 134 could be machine-to-machine, web-based, or chat-based.

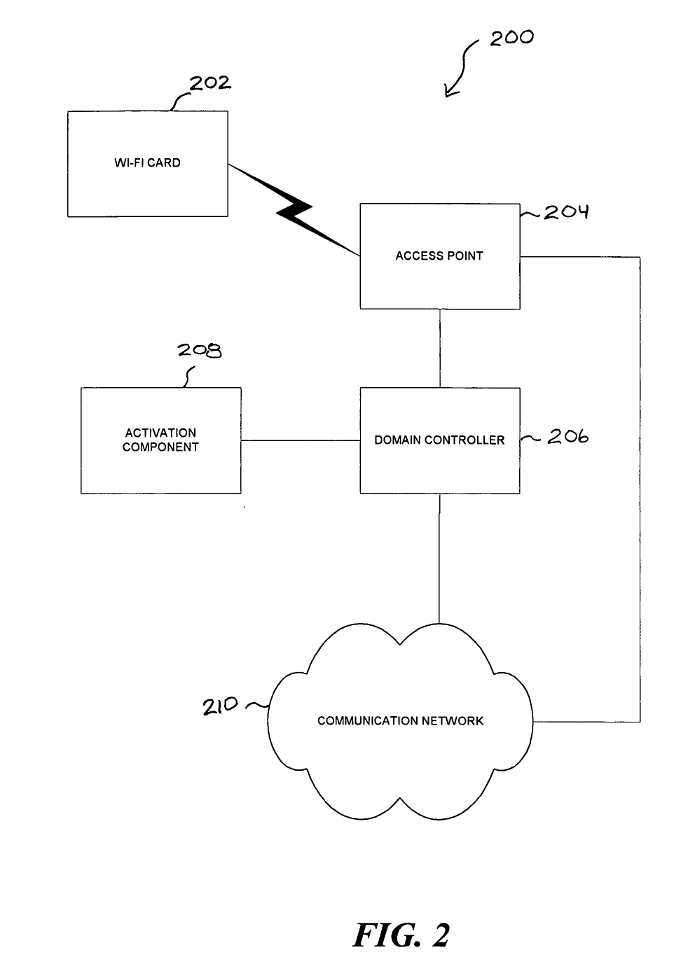

Referring to FIG. 2, the activation of the inactive device may also be implemented in a Wi-Fi network configuration 200, based, for example, on the 802.11a, 802.11b, 802.11(g), and other standards for wireless LANs by the Institute of Electrical and Electronic Engineers (IEEE). Other standards that implement a wireless local network using high frequency radio signals or other means to transmit and receive data over distances of a few hundred feet may also be used, including Bluetooth, Ultrawideband, ZigBee, etc.

In the illustrated embodiment, a Wi-Fi card 202 or similar component in the mobile device communicates with an access point 204 by sending signals from a transmitting antenna that is linked to the wired access point 204. A domain controller 206 provides access controls over users, accounts, groups, computers, and other network resources, including a communications network 210 of the wireless service provider and an activation component 208, so that a user of the mobile device can activate the device via the device. For example, the activation component 208 may include access to a web site or to another feature that allows the user to provide activation information.

Referring to FIG. 3, an activation component 300 (such as the activation server 126 of FIG. 1 and the activation component 208 of FIG. 2) may contain several features that facilitate the activation of the mobile device. For example, the activation component 300 may include account set-up applications 302 and an activation network interface 304 that allows access from the activation network 116 (or domain controller 206). User help applications 306 provide instructions to a user of a mobile device to help facilitate activation by the user. An IT network interface 308 allows the activation component 300 to communicate with the IT network 118, so that, for example, the provisioning server 128 can be directed to write to the HLR 112 and update the device's status to active.

Unless described otherwise below, aspects of the invention may be practiced with conventional systems. Thus, the construction and operation of the various blocks shown in FIGS. 1-3 may be of conventional design, and need not be described in further detail herein to make and use the invention, because such blocks will be understood by those skilled in the relevant art. One skilled in the relevant art can readily make any modifications necessary to the blocks in FIGS. 1-3 (or other embodiments or Figures) based on the detailed description provided herein.

III. Mobile Device Identification

As described above, in some embodiments, the mobile device, or a module in the mobile device (such as a SIM card) is configured with a permanent identifier so that the device, even when not yet activated, may be recognized at the service provider network. In some embodiments, the permanent identifier may be specific to the type of network provided by the service provider. For example, in a GSM-type network, the identifier may be in the form of an international mobile subscriber identifier (IMSI) or a national mobile station identity (NMSI). In an AMPS/TDMA network, the identifier may be associated with a mobile identification number (MIN). Many different types of mobile identifier may be used without departing from the scope of the invention.

In the case of wireless phones, the phone number or mobile directory number (MDN) of the device, traditionally used in the context of public switched telephone networks, may or may not play a role in the activation process. In some embodiments, the MDN is not known by the device at the time that the activation process takes place. Accordingly, the HLR may store an MDN to provide to the device once it becomes activated. The HLR may also store a dummy MDN or a default MDN for the device, which may or may not be written over at the time provisioning or activation takes place. The activation server may also rely on an external database to get an MDN for the device.

Like the MDN, the serial number of the device may or may not play a role in the activation process. The serial number is sometimes referred to as an electronic serial number (ESN) and is separate and distinct from the permanent identifier described above.

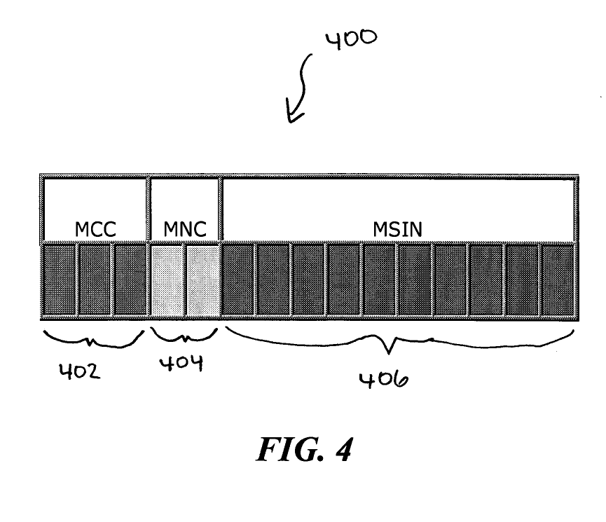

Referring to the illustrated example of FIG. 4, an international mobile subscriber identifier (IMSI) 400 consisting of a sequence of codes may be stored in the SIM card of the device when it is shipped from the manufacturer, or subsequently added to the mobile device. In the illustrated embodiment, the IMSI 400 includes up to fifteen digits and contains three parts: The mobile country code (MCC) 402 consists of three numbers used to identify the home country of the device for international applications. The mobile network code (MNC) 404 consists of two to three numbers used to identify the network and service provider with whom the subscriber has an account. The mobile station identification number (MSIN) 406 consists of nine to ten numbers used to uniquely identify the device at the service provider network.

In a GSM system, the inactive or active mobile device transmits the IMSI when it is switched on and searching for available base stations. It chooses the most appropriate base station and sends a message (including the IMSI) to this base station to register or affiliate to the network of the service provider (known via the MNC of the IMSI). If the network recognizes the device as being inactive, it allows access to the activation network. If the network recognizes the device as being active, it allows access to additional portions of the network.

In some embodiments, once a mobile device has affiliated with the network, the network allocates a temporary IMSI (TIMSI), which is used to identify the subscriber in future exchanges as long as the device remains continuously accessible to the network (e.g., not turned off or out of range). This provides limited security or privacy, as it reduces the number of times the IMSI is transmitted over the air.

IV. System Flows

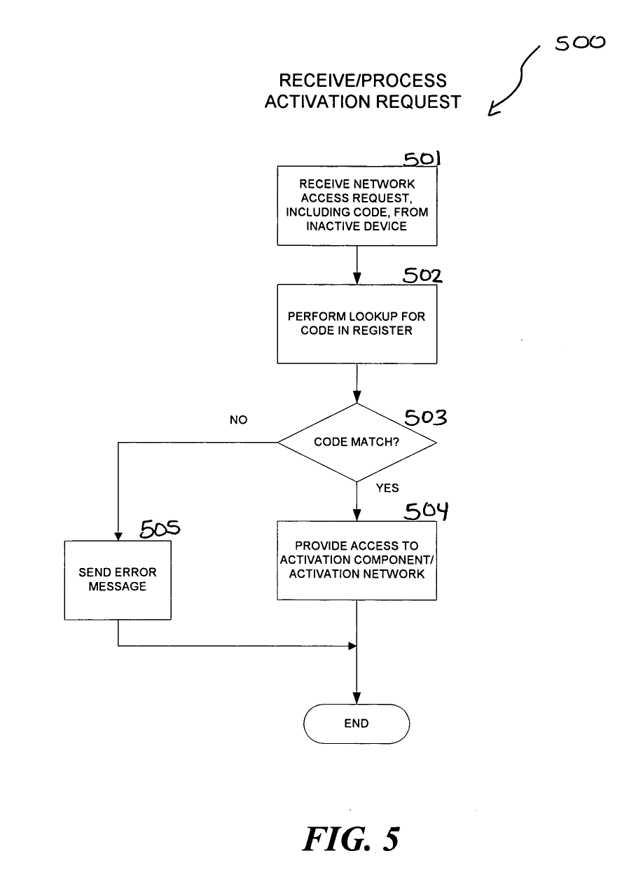

FIGS. 5-8 are representative flow diagrams that depict mobile device activation processes used in some embodiments. These flow diagrams do not show all functions or exchanges of data, but instead they provide an understanding of commands and data exchanged under the system. Those skilled in the relevant art will recognize that some functions or exchanges of commands and data may be repeated, varied, omitted, or supplemented, and other (less important) aspects not shown may be readily implemented.

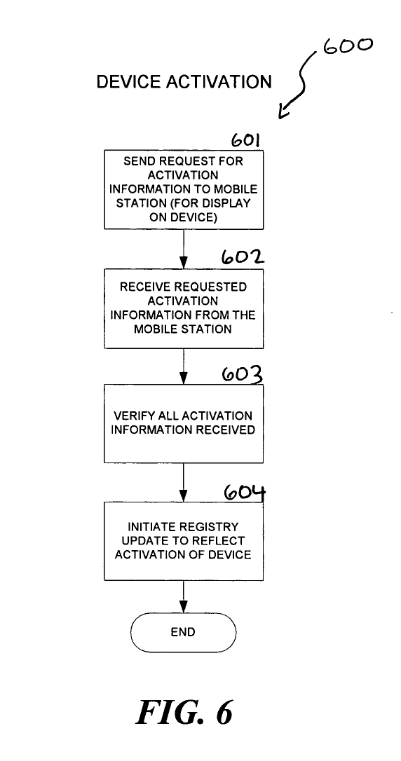

Referring to FIG. 5, the wireless service provider processes an inactive mobile device's request for access to its communications network by performing a process activation request routine 500. At block 501, the routine 500 receives, from the inactive device, a request for access to the network. For example, the request may be a registration or affiliation request passed on from a base station, such as the base station 104 of FIG. 1. The request includes a permanent identifier for the device, such as an IMSI. At block 502 the routine 500 performs a lookup based on the permanent identifier. For example, the routine 500 may perform a lookup for a matching record in the HLR of the wireless service provider. At decision block 503, if there is no match of the permanent identifier, the routine 500 sends an error message to the mobile device (block 505) and then ends. If, however, at decision block 503 there is a match of the permanent identifier, then at block 504 the routine 500 authorizes access to an activation component at the wireless service provider. As described with respect to FIGS. 1-3, the activation component may include an activation network and/or an activation server. This restricted access to the wireless service provider system allows the user of the device to provide information that facilitates activation of the device, as described in more detail with respect to FIG. 6.

Referring to FIG. 6, the activation portion or component of the wireless service provider system performs an activation routine 600 to allow an untrained user of the mobile device to activate the mobile device from the mobile device. This activation routine 600 assumes that the mobile device currently has access to the activation portion or component of the wireless service provider system. At block 601, the routine 600 sends a request for activation information to the mobile device. In some embodiments, the request for activation information may include a request for a selection of a service plan or subscription that is displayed in text and/or graphics on the display of the mobile device; in other embodiments, the requests may be presented to the user in audio. For example, the user may be requested to select from a variety of bucket plan options or service features. The request for activation information may also include a request for billing and personal information (e.g., name and address, credit card number, billing address, etc.). Various instructions may also be included with the request for activation information. As the inactive device may have permission to send and receive SMS messages, in some embodiments, the instructions and requests for activation information may be in the form of SMS messages.

At block 602, the routine 600 receives requested information, as input by the user of the mobile device. In some embodiments, the received information may also be transmitted in the form of an SMS message. If additional information is needed based on the received information, the routine 600 may send additional requests (not shown). At block 603, the routine 600 verifies that all required activation information has been provided. At block 604, the routine 600 updates the HLR to reflect that the device has been activated. For example, the status of the device may be updated from “inactive” to “active.” The device can then enjoy less restricted access to the network of the wireless service provider.

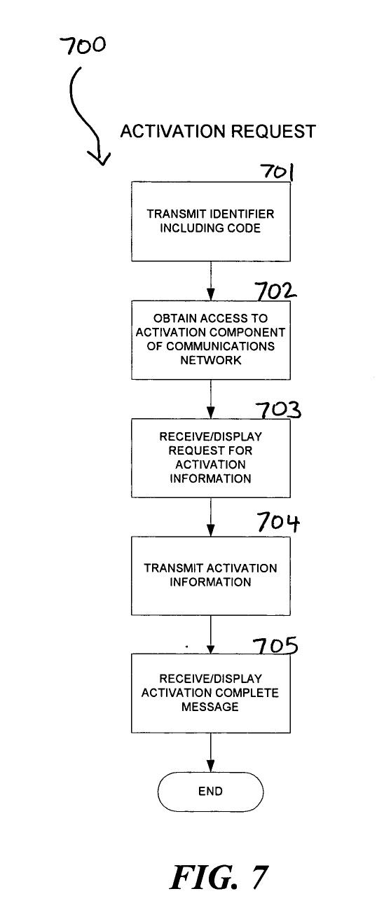

Referring to FIG. 7, an inactive mobile device performs a routine 700 for requesting activation. At block 701, upon being powered on, the mobile device sends a message, which includes its permanent identifier, in a request for affiliation to the network of the wireless service provider. However, in some embodiments, the mobile device may not send the message until another action is taken (e.g., the user pushes a button, etc.). At block 702, the inactive mobile device gains access to an activation component at the wireless service provider. At block 703, the mobile device receives a request for activation information. The device presents this request to the user of the device (e.g., on a display screen, through a speaker, etc.). At block 704, the device transmits inputted activation information to the activation network. At block 705, the device receives a message that the activation is complete.

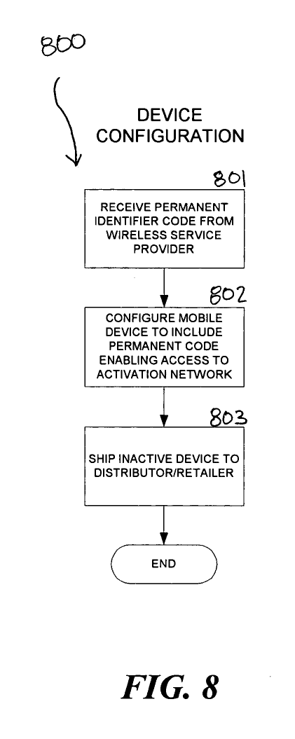

Referring to FIG. 8, a manufacturer of a mobile device performs a process 800 for configuring a mobile device so that a user who is not trained in device activation may activate the mobile device via the mobile device. At block 801, the manufacturer receives a permanent identifier code, which will be or is known by a select service provider. The select service provider stores information associated with this identifier code at an appropriate HLR or other network node (e.g., in a data record or customer record). At block 802, the manufacturer configures the mobile device to include the permanent identifier code that will allow the device to have access to at least a portion of the network of the select service provider (such as an activation component). For example, the manufacturer may program the identifier code into a SIM card in the device. At block 803, the manufacturer ships the inactive and configured device to a distributor or retailer so it may be purchased from an end user and then activated from the mobile device.

While the routines described in the above flow charts may describe a specific type, source, or destination of information (e.g., indicating that information comes from the mobile device), the type, source, or destination of the information handled in the routines, may vary without departing from the scope of the invention. In addition, the sources or destinations of information described above (as well as the information itself may be combined, modified, or streamlined. For example, certain elements of information may be supplied by the personal base station (such as the personal base station 134 of FIG. 1) instead of by the mobile device, or certain elements of information may be derived from but not directly provided by other components in the network(s).

V. Conclusion

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Additionally, the words “herein,” “above,” “below,” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times. Where the context permits, words in this Detailed Description using the singular or plural number may also include the plural or singular number respectively.

The teachings of the invention provided herein could be applied to other systems, not necessarily the system described herein. The elements and acts of the various embodiments described above can be combined to provide further embodiments.

The following commonly-owned patents and applications are herein incorporated by reference: U.S. Pat. No. 6,490,445 entitled “Customer Activation System For Cellular Network,” filed Jul. 19, 2000, and U.S. patent application Ser. No. ______, (attorney docket no. 101948105) entitled “Customer Service Messaging, Such as on Mobile Devices,” filed Jul. 15, 2005. Aspects of the invention can be modified, if necessary, to employ the systems, functions, and concepts of the various references described above to provide yet further embodiments of the invention.

While the above description details certain embodiments of the invention and describes the best mode contemplated, no matter how detailed the above description appears in text, the invention can be practiced in many ways. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless this Detailed Description section explicitly defines such terms. Accordingly, the actual scope of the invention encompasses not only the disclosed embodiments, but also all equivalent ways of practicing or implementing the invention under the claims.

While certain aspects of the invention are presented below in certain claim forms, the inventors contemplate the various aspects of the invention in any number of claim forms. Accordingly, the inventors reserve the right to add additional claims after filing the application to pursue such additional claim forms for other aspects of the invention.

I/we claim:

1. At a wireless service provider system, a method for facilitating activation of a mobile station so that the mobile station can have less-restricted access to a communications network of the wireless service provider system, the method comprising:
receiving, from the mobile station, a request for access to the communications network of the wireless service provider system, wherein the request includes a code corresponding to an international mobile subscriber identifier (IMSI) permanently associated with a mobile station subscriber identity module (SIM) card in the mobile station;
determining whether the code corresponding to the international mobile subscriber identifier (IMSI) corresponds with a code stored in a record of a home location register (HLR) associated with the wireless service provider system;
if the code corresponding to the international mobile subscriber identifier (IMSI) corresponds with the code stored in the record of the home location register (HLR), providing the mobile station with restricted access to the communications network of the wireless service provider system, wherein the restricted access to the network of the wireless service provider system includes access to an activation portion of the wireless service provider system;
at the activation portion of the wireless service provider system, receiving activation information from the mobile station; and
based on the received activation information, updating the record of the home location register (HLR) to indicate that the mobile station has less-restricted access to the wireless network of the wireless service provider system.

2. The method of claim 1, further comprising assigning a temporary international mobile subscriber identifier (TIMSI) to the mobile station, wherein the mobile station transmits the temporary international mobile subscriber identifier (TIMSI) in place of the international mobile subscriber identifier (IMSI) in future exchanges with the wireless service provider system, as long as the mobile station remains continuously accessible to the network of the mobile service provider.

3. The method of claim 1, further comprising sending a request for activation information to the mobile station, wherein the request for activation information is presented to a user of the mobile station.

4. At a wireless service provider system, a method for facilitating activation of a mobile device so that the mobile device can have increased access to a communications network of the wireless service provider system, the method comprising:
receiving a request for access to the communications network of the wireless service provider system, wherein the request includes a nontemporary code identifying the mobile device or a module in the mobile device, and wherein the request does not include a temporary identifier;
based on the nontemporary identification code, searching one or more records to determine whether the mobile device is recognized by the wireless service provider system and whether the mobile device has an inactive status; and
if the mobile device is recognized by the wireless service provider and has an inactive status, providing the mobile device with restricted access to the network of the wireless service provider system, wherein the restricted access to the network includes access to a portion of the wireless service provider system that facilitates wireless activation of the mobile device by a user of the mobile device who is not trained in device activation.

5. The method of claim 4, further comprising:
receiving activation information from the mobile device; and
based on the received activation information, updating the status of the mobile device from inactive to active.

6. The method of claim 4, further comprising:
receiving activation information from the mobile device; and
based on the received activation information, updating the status of the mobile device from inactive to active, including updating at least one of the one or more records to indicate that the device is permitted to have increased access to the network.

7. The method of claim 4 wherein the nontemporary identification code identifies both the mobile device and the wireless service provider system.

8. The method of claim 4 wherein the nontemporary identification code corresponds to an international mobile subscriber identifier (IMSI).

9. The method of claim 4 wherein the permanent identifier is associated with a subscriber identity module (SIM) card in the mobile device.

10. The method of claim 4, further comprising:
sending a request for activation information to the mobile device, wherein the request for activation information is for presentation to a user of the mobile device;
receiving activation information from the mobile device in response to the sent request; and
based on the received activation information, updating the status of the mobile device from inactive to active.

11. The method of claim 4, further comprising receiving activation information from the mobile device, wherein the activation information includes an indication of a selected service plan.

12. The method of claim 4, further comprising receiving activation information from the mobile device, wherein the activation information includes billing information.

13. The method of claim 4 wherein the communications network includes at least one wireless local network that uses high frequency radio signals to transmit and receive data over distances of a few hundred feet, wherein the wireless device communicates, at least in part, via the wireless local network.

14. The method of claim 4 wherein the communications network includes a Wi-Fi network, wherein the wireless device communicates, at least in part, via the Wi-Fi network, and wherein the portion of the wireless service provider system that facilitates activation of the mobile device includes a domain controller that allows the wireless device to access an activation web site.

15. At a mobile station, a method for activating the mobile station so that it has increased access to a communications network, the method comprising:
transmitting a permanent identifier including a code identifying the mobile station or a module in the mobile station, wherein the code identifying the mobile station or the module in the mobile station is known to at least one component of the communications network prior to activation;
based on the transmitting, obtaining access to an activation component of the communications network, wherein the activation component facilitates wireless activation by an untrained end user of the mobile station;
receiving a request for activation information from the activation component; and
transmitting activation information to the activation component so that the activation component can update the status of the mobile station from inactive to active.

16. The method of claim 15 wherein the permanent identifier is associated with a subscriber identity module (SIM) card in the mobile station.

17. The method of claim 15 wherein the permanent identifier is associated with an international mobile subscriber identifier (IMSI).

18. The method of claim 15, further comprising displaying the request for activation information on a display at the mobile station.

19. A communications service provider system configured for facilitating the activation of a communications device so that the communications device can have an increased level of access to one or more communications networks associated with the communications service provider system, the system comprising:
means for receiving, from the communications device, a request for access to a communications network of the communications service provider system, wherein the request includes a nontemporary code identifying the communications device or a module in the communications device, and wherein the request does not include a temporary identifier associated with the communications device;
means for searching one or more records to determine whether the communications device is recognized by the communications service provider system and whether the communications device has an inactive status; and
means for providing the communications device with restricted access to the network of the communications service provider system, wherein the restricted access to the communications network includes access to a portion of the communications service provider system that facilitates activation of the communications device.

20. The system of claim 19 wherein the communications device is a personal computer.

21. The system of claim 19 wherein the communications device includes an enhanced data rates for global evolution (EDGE) card.

22. The system of claim 19 wherein the communications device is a mobile terminal.

23. The system of claim 19 wherein the communications device is a mobile phone.

24. The system of claim 19 wherein the communications service provider system provides Internet services.

25. The system of claim 19 wherein the communications service provider system provides media entertainment services.

26. A method for configuring a mobile device so that it can be provided to a customer in a nonactivated state, wherein the mobile device can then be activated by an end user so that the mobile device can have increased access to services provided by a wireless service provider, the method comprising:
receiving a permanent identifier code from a wireless service provider; and
configuring a memory associated with the mobile device so that the memory includes the permanent identifier code, such that the mobile device may then be activated by a method comprising:
transmitting the permanent identifier code to a station accessible by the wireless service provider;
based on the transmitting of the permanent identifier code, obtaining access to an activation component of the wireless service provider;
receiving a request for activation information from the activation component; and
transmitting activation information to the activation component so that the activation component can update the status of the mobile device from inactive to active.

27. At a personal base station, a method for facilitating activation of a mobile station so that the mobile station can have less-restricted access to a network of a wireless service provider system, wherein the personal base station is controlled, at least in part, by an end user of the mobile device who is not trained in activation methods, the method comprising:
receiving, from the mobile station, a request for access to the network of the wireless service provider system, wherein the request includes a nontemporary code identifying the mobile station or a module in the mobile station, and wherein the request does not include a temporary identifier; and
providing the mobile station with restricted access to the network of the wireless service provider system, wherein the restricted access to the network includes access to a portion of the wireless service provider system that facilitates activation of the mobile station, so that the mobile station can complete activation by a method comprising:
receiving a request for activation information from an activation component of the wireless service provider system; and
transmitting activation information to the activation component so that the activation component can update the status of the mobile station from inactive to active.

28. The method of claim 27 wherein the provided access to the network of the wireless service provider system includes machine-to-machine access.

29. The method of claim 27 wherein the provided access to the network of the wireless service provider system includes web-based access.

30. The method of claim 27 wherein the provided access to the network of the wireless service provider system includes chat-based access.

31. An activation component of a mobile communications network, the activation component comprising:
means for communicating with an untrained end user of a mobile device for the purpose of activating the mobile device so that the mobile device may obtain access to the mobile communications network;
means for providing instructions for permitting the untrained end user to provide information for wireless activation of the mobile device, using the mobile device; and
means for facilitating the update of a record in a customer record component of the mobile communications network, wherein information stored in the record at the customer record component determines the level of access to the mobile communications network, both before and after the device is activated.
